(19) United States
(12) Patent Application Publication
(10) Pub. No.: US 2011/0204614 A1
(43) Pub. Date: Aug. 25, 2011

(54) Universal Mud Flap

(76) Inventor: Joseph Cicansky, Regina (CA)

(21) Appl. No.: 12/710,428

(22) Filed: Feb. 23, 2010

(51) Int. Cl. B62D 25/18; B29C 37/00

(52) U.S. Cl. 280/851; 264/138

(57) ABSTRACT

The universal mudflap has a generally planar, integrally molding a body including a front face and a rear face spanning between a top mounting end and a bottom flap end arranged to suspend from the vehicle. A plurality of cutting guide lines are integrally molded into the front face of the molded body in which the plurality of cutting guide lines represent at least two different patterns corresponding to respective different configurations of the top mounting end such that the mudflap is arranged for readily mounting on respective vehicles having different mud flap mounting configurations. The method of forming the mudflap includes the end user selecting the pattern corresponding to the mud flap mounting configuration of their vehicle and cutting the body along the cutting guide lines of only the selected pattern.

### FIELD OF THE INVENTION

The present invention relates to a mud flap for motor vehicles having a main body with top mounting end arranged to be supported on a vehicle and a bottom flap end arranged to be suspended from the vehicle between the top mounting end, and more particularly the present invention relates to a mud flap in which the top mounting end includes cutting guide lines arranging the mud flap to be readily configured for many different vehicle mud flap mounting configurations.

### BACKGROUND

Various forms of mud flaps are commonly mounted on vehicles rearward of each of the wheels to protect the vehicle and following traffic from various water and debris thrown up from the wheels during travel. Mud flaps are typically mounted in the wheel well at the rear end thereof such that a rear face of the mud flap is mounted against a forward facing portion of the vehicle body. Many types of aftermarket mud flaps are known which are intended to mount to different types of vehicles. It is desirable therefore to permit the mud flap to be adjusted relative to the vehicle so that the mud flap can be closely matched in profile to different types of vehicles in an optimal and well supported manner. Examples of prior art mud flaps are disclosed in the following.

U.S. Pat. No. 3,279,818 by Jones discloses a mud flap in which a plurality of mounting apertures are provided at varying elevations adjacent the top mounting end of the mud flap such that the mounting of the mud flap is height adjustable in relation to the vehicle. Although the height can be adjusted, the configuration of the mud flap is limited to a consistent vehicle mud flap mounting configuration.

U.S. Pat. No. 4,315,634 by Arenhold discloses a mud flap in which bending lines are provided in the body of the mud flap such that the mud flap may be more readily flexed to follow the varying contour of different vehicle bodies. While providing some adjustment to the mounting configuration, the mere bending of the mud flap body still limits the number of applications where the mud flap can be mounted. Furthermore separate right and left hand configurations of the mud flap must be manufactured.

U.S. Pat. No. 4,877,268 by Price discloses a further configuration of a mud flap body which must also be manufactured in separate right and left hand configurations to match the contour of the body. Components of the packaging are described as being used as a template to better match the profile of the mud flap to the vehicle body, however the use of packaging as a template requires a complex two-step cutting operation of forming the template first followed by shaping of the mud flap. There is no clear indication of any specific patterns so that the skill of the end user installing the mud flap is relied upon entirely for insuring a proper fit of the mud flap to the vehicle.

### SUMMARY OF THE INVENTION

According to one aspect of the invention there is provided a universal mud flap comprising:

a molded body having a front face and a rear face spanning between a top mounting end arranged to be supported on a vehicle and a bottom end arranged to be suspended from the vehicle below the top mounting end;

a plurality of cutting guide lines integrally molded into at least one face of the molded body;

the plurality of cutting guide lines comprising at least two different patterns corresponding to respective different configurations of the top mounting end so as to be arranged for mounting on respective vehicles having different mud flap mounting configurations.

According to a second aspect of the present invention there is provided a method of forming a mudflap to correspond to a prescribed vehicle, the method comprising:

integrally molding a body comprising a front face and a rear face spanning between a top mounting end and a bottom end, and a plurality of cutting guide lines integrally molded into at least one face of the molded body in which the plurality of cutting guide lines comprise at least two different patterns corresponding to respective different configurations of the top mounting end which are arranged for mounting on respective vehicles having different mud flap mounting configurations;

selecting the pattern corresponding to the mud flap mounting configuration of said prescribed vehicle; and

cutting the body along the cutting guide lines of only the selected pattern.

The method may further comprise:

molding the body such that the guide lines and the perimeter edge are raised in relation to respective recessed portions of the front face spanning between the guide lines and the perimeter edge; and

cutting the body alongside selected ones of the cutting guide lines such that said selected ones of the cutting guide lines remain attached to the bottom end of the body and form a portion of a perimeter edge of the body after cutting the body.

By providing integrally molded guide lines corresponding to plural different patterns on the mud flap body itself, and which may be symmetrical, a single mud flap can be manufactured which allows considerable custom fitting to either left or rights sides of many different vehicles having different mud flap mounting configurations. By specifically indicating the outline of various patterns integrally on the molded body of the mud flap, the end user is only required to follow an already pre-determined pattern on the mud flap to ensure a proper fit with the selected vehicle.

Preferably the guide lines are integrally molded into only the front face of the molded body and are symmetrical about an axis which is centered in a lateral direction between opposing side edges and which extends vertically between the top mounting end and the bottom end.

The cutting guide lines may be raised in relation to respective recessed portions spanning between the cutting guide lines in the front face.

When there is provided a perimeter edge which is raised in relation to a central portion of the front face and the cutting guide lines are raised in relation to the central portion, preferably the cutting guide lines are joined to the perimeter edge and have a substantially identical thickness between the front and rear faces of the body as the perimeter edge.

Preferably the cutting guide lines span substantially a full thickness of the body between the front and rear faces of the body.

When there is provided a plurality of vertically oriented raised ribs on the front face of the body adjacent the bottom end and the cutting guide lines are raised in relation to respective recessed areas spanning between the cutting guide lines, preferably the guide lines adjacent the top end have a thickness between the front and rear faces of the body corresponding to a majority of a thickness of the ribs between the faces and the cutting guide lines adjacent the ribs have a thickness which is substantially equal to the thickness of the ribs.

When the top edge of the top mounting end of the body comprises a pair of extension portions extending vertically upward from the body adjacent opposing side edges in relation to a central portion of the top edge, preferably each extension portion comprising one of the cutting guide lines spanning thereacross between the respective side edge and the central portion of top edge.

In this instance, the guide lines preferably comprise two guide lines which extend across the face of the body downwardly and inwardly from respective inners sides of the extension portions towards one another to a central apex spaced below the top edge of the body.

When the guide lines comprise two guide lines in a substantial V-shape which extend across the face of the body downwardly and inwardly from spaced apart positions at the top mounting end to a central apex spaced below the top edge of the body, preferably another one of the guide lines spans laterally between opposing side edges of the body across the central apex.

The cutting guide lines may further include a central guide line extend downwardly from the central apex and a pair of guide lines extending downwardly from the two guide lines in a substantial V-shape at spaced apart positions on opposing sides of the central guide line, in which the central guide line and said pair of guide lines are joined at respective bottom ends spaced below the central apex.

The guide lines and a top edge of the top mounting end may have an identical thickness between the front and rear faces of the body. There may also be provided a raised rib spanning horizontal across the front face locating the guide lines thereon in which the raised rib is spaced below the top edge and has an identical thickness between the front and rear faces of the body as the top edge.

The universal mud flap may be used in combination with a mounting bracket having apertures formed therein in alignment with aperture receiving locations on the body adjacent the top mounting end. In some instances, the different mounting configurations of the different patterns of the cutting guide lines correspond to different mounting brackets.

There may be provided a plurality of aperture receiving locations on the body, each comprising a raised protrusion and a central recess in the raised protrusion which are integrally molded in the body.

There may be provided a metallic accent plate integrally molded into the rear face of the body adjacent the bottom end and opposite the cutting guide lines in the front face.

One embodiment of the invention will now be described in conjunction with the accompanying drawings in which:

### BRIEF DESCRIPTION OF THE DRAWINGS

FIG. 1 is perspective view of the front face of the integrally molded mud flap body.

FIG. 2 is a perspective view of the front face corresponding to a first pattern and first mounting configuration of the mud flap where one of the two extension portions of the molded body are removed, and where a mounting bracket is used to optimally support the mud flap on the vehicle.

FIG. 3 is a perspective view of a second mounting configuration corresponding to a moon cut which is shown in a passenger side configuration.

FIG. 4 is a perspective view of the front face in a third mounting configuration including an additional central portion removed to follow the profile of the vehicle body of one particular vehicle mounting configuration.

FIG. 5 is a cross-sectional view generally along the line 5-5 of mudflap prior to cutting as shown in FIG. 1.

FIG. 6 is an elevational view of the rear face of the mud flap according to FIG. 1.

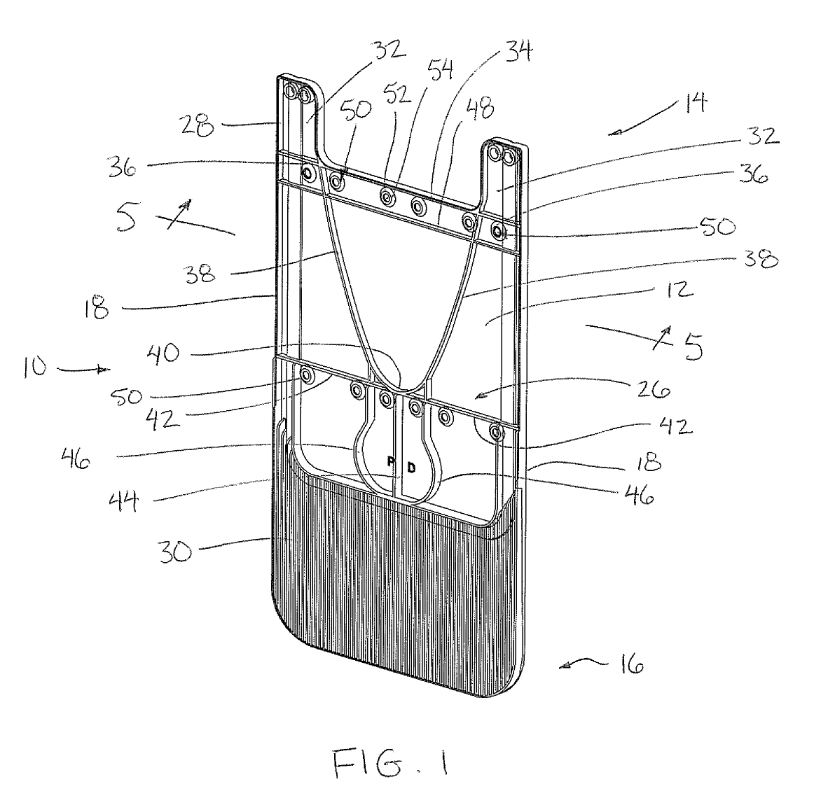

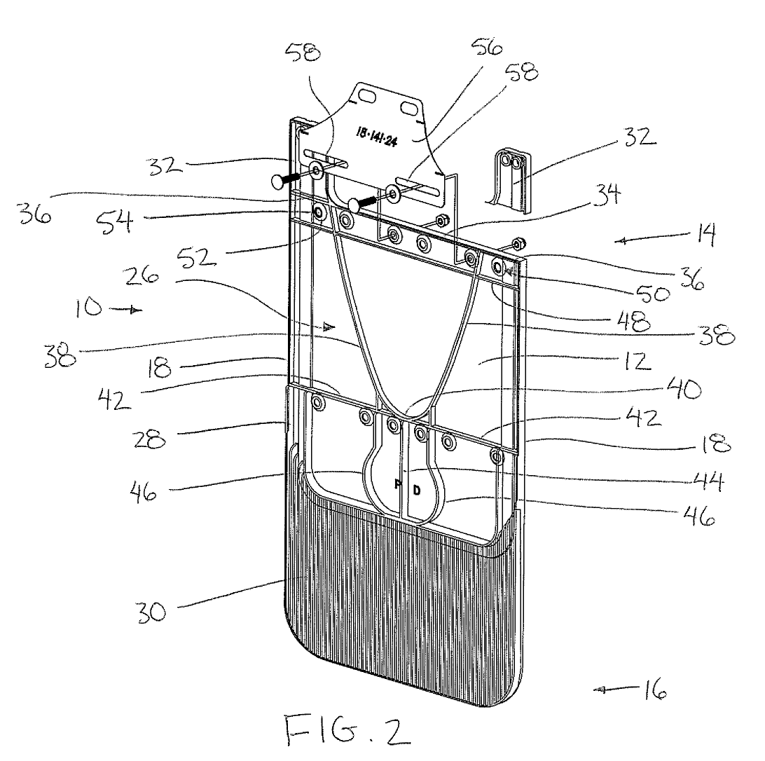

In the drawings like characters of reference indicate corresponding parts in the different figures.

### DETAILED DESCRIPTION

Referring to the accompanying figures, there is illustrated a universal mud flap generally indicated by reference numeral 10. The mud flap 10 is particularly suited for being re-shaped by the end user to vary the shape and mounting configuration thereof to match the mounting configurations of many different vehicle types.

The mud flap generally comprises a single molded body 12 formed of plastic, rubber or any other suitable material which can be suitably molded into the shape described in the following. The body 12 is generally planar in construction and has a generally rectangular outer shape. The body 12 extends generally in a longitudinal direction between a top mounting end 14 and a bottom flap end 16. Laterally opposed side edges 18 extend along opposing sides of the body in the longitudinal direction between the top and bottom ends. The two side edges 18 form a perimeter of the mud flap with the top edge and the bottom edge at the top and bottom ends respectively.

The body includes a rear face 20 which is generally flat at a top mounting end for substantially flush mounting against a forward facing rear wall of a wheel well in most applications. A lower portion of the rear face extending upward from the bottom end of the mud flap is arranged to be suspended from the vehicle to define a flap portion suspended from the top end mounted on the vehicle.

The rear face includes a lower decorative portion 22 adjacent the bottom end in the flap portion which is generally rectangular in shape and which is integrally molded into the rear face. The rectangular decorative portion 22 in a first configuration is integrally molded with the body to have a textured surface surrounded by a peripheral groove in the rear face. In alternative arrangements a metallic accent plate forms the decorative portion 22 in which the accent plate is integrally molded into the rear face so as to be recessed in relation thereto and surrounded about a periphery by the overlapping rear face.

The rear face further comprises an upper decorative portion 24 which is also integrally molded into the rear face to have a textured surface. A peripheral groove surrounds the bottom and two sides of the upper decorative portion such that the groove is generally U-shaped in the rear face with the two sides of the groove extending upwardly to join the top edge.

The opposing front face 26 is also flat and includes a main portion having a first thickness relative to the rear face. The front face includes a peripheral wall 28 about the full peripheral edge of the body which projects outward from the main portion of the front face perpendicularly to the generally planar direction of the body such that the peripheral wall 28 of the front face defines a second overall thickness of the mud flap between the front and rear faces. A lower portion of the peripheral side edges and the bottom edge include a peripheral wall having a greater thickness between front and rear faces than an upper portion of the peripheral wall along the side edges and top edge. The thickness at the upper portion corresponds to at least a majority of the thickness of the lower portion.

The lower portion of the front face further includes a plurality of raised ribs 39 which extend vertically in the longitudinal direction across the front face upwardly from the bottom end to an intermediate location on the body. The ribs comprise upstanding walls projecting perpendicularly outward from the main portion of the front face and have an overall thickness which is substantially identical to the maximum thickness of the mud flap and the thickness of the peripheral wall of the lower portion as measured between the front and rear faces.

The upper portion of the front face 26 includes a plurality of cutting guide lines formed therein which are integrally molded to be continuous and seamless with the material forming the body. The guide lines are only formed on the front face of the mud flap and follow the outline of a plurality of different patterns in which each pattern corresponds to a different configuration of the top mounting end of the mud flap which is in turn suited for mounting on respective different mud flap mounting configurations of different vehicles.

Each guide line comprises an upright wall projecting outward from the main central portion of the front face such that the guide lines have the same thickness between front and rear faces as the corresponding portion of the perimeter wall 28 about the peripheral edge of the body so as to span the full thickness of the body between the front and rear faces. The guide lines are all joined to one another and to the perimeter edge wall such that the guide lines surround and define a plurality of recessed areas of the main portion of the front face which span between the cutting guide lines. The thickness of the guide lines between front and rear faces correspond to the same greater thickness as the raised ribs 30 adjacent the lower portion of the mud flap while having a thickness corresponding to the upper perimeter walls and other guide lines adjacent the upper end, which in turn corresponds to a majority of the thickness of the raised ribs.

The top edge of the body of the mud flap comprises two extension portions 32 which extend in the longitudinal direction upwardly beyond a central portion 34 of the top edge. The two extension portions 32 are positioned at opposing sides of the body so as to be flush with the side edges thereof while also being substantially coplanar with the front and rear faces of the body. The perimeter wall 28 follows the perimeter of the two extension portions 32 and the central portion 34 therebetween. The central portion extends in a lateral direction between the two opposing side edges so as to be generally horizontal and perpendicular to the vertical direction of the mud flap.

The guide lines include various configurations spanning across the front face to define the various patterns of different mounting configurations of the top mounting end. The guide lines include two top guide lines 36 at opposing ends of the peripheral wall spanning the central portion 34 of the top edge such that each of the top guide lines spans in a lateral direction across a respective one of the extension portions 32 between the central portion and the respective side edge of the body. The first mounting configuration of the mud flap is arranged by removing one of the extension portions 32 by cutting along the top of a corresponding one of the top guide lines 36.

The guide lines further comprise two V-shaped guide lines 38 comprising two lines extending downwardly and inwardly towards one another from respective top ends at the inner sides of the extension portions 32 respectively. The bottom ends of the two V-shaped guide lines 38 are joined to one another at an apex 40 which is centered in the lateral direction and is approximately centered in the longitudinal direction of the mud flap. The apex 40 is generally curved in profile between the two guide lines 38 so as to be generally parabolic in shape.

The guide lines further comprise two lateral guide lines 42 extending laterally outward in opposing directions from the apex to respective side edges. The two lateral guide lines 42 thus form one continuous guide line spanning horizontally between the perimeter wall at opposing sides, extending across the apex and perpendicularly to the longitudinal direction. A moon cut mud flap can be formed by cutting along one of the V-shaped guide lines 38 on one side of the mud flap together with one of the lateral guide lines 42 on the opposing side of the body joined at the apex 40 such that the mud flap follows a common vehicle body contour. The two V-shaped guide lines 38 correspond to opposing left and right hand mudflap configurations.

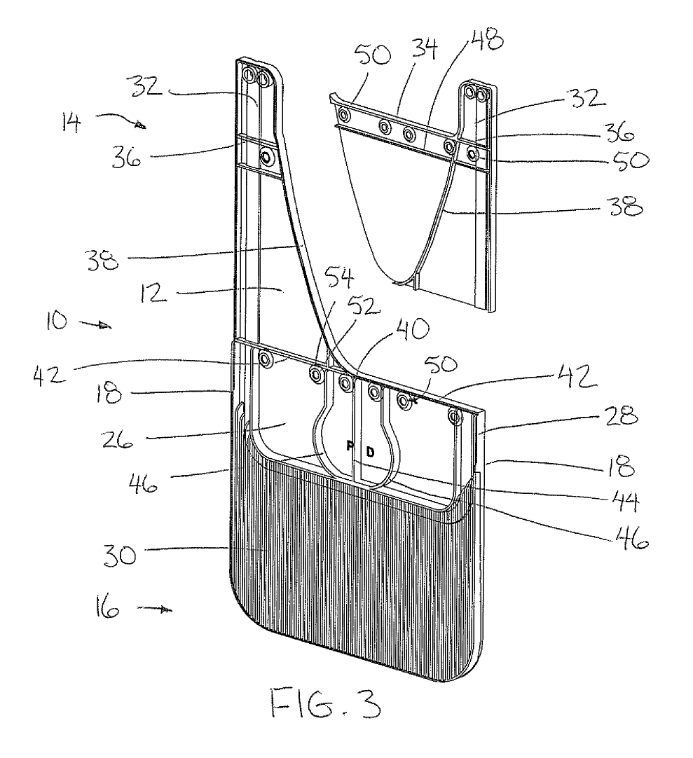

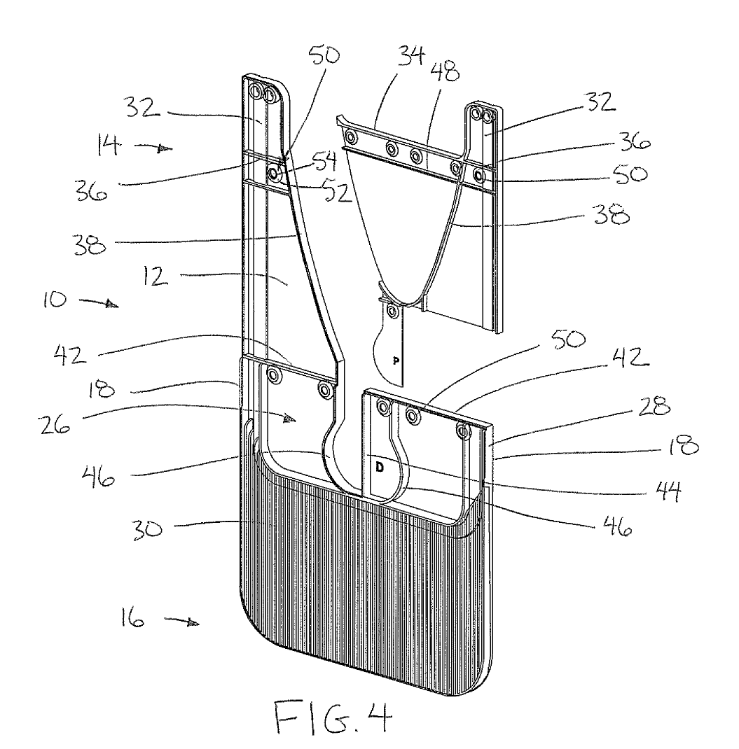

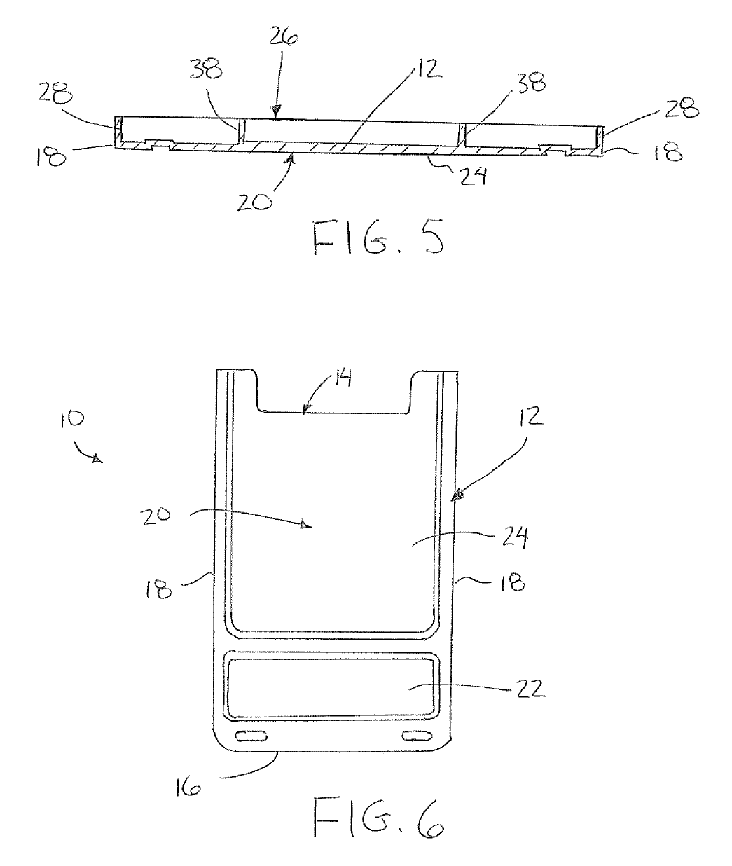

The guide lines further comprise a center guide line 44 extending vertically downward from the apex 40 at a central location in the lateral direction between the opposing side edges. The center guide line 44 extends downward to a bottom end at the top of the raised ribs corresponding approximately to the top of a lower portion of the mud flap. Two lower guide lines 46 are also provided at laterally spaced apart positions on opposing sides of the center guide line 44 in which the two lower guide lines extend generally downward from the two V-shaped guide lines 38 at intermediate locations thereon spaced apart on opposing sides on the central apex. The two lower guide lines 46 are joined with one another and with the bottom end of the center guide line 44 at respective bottom ends to define two symmetrical center cut-out portions. One of the cut-out portions can be removed together with the moon cut configuration described in FIG. 3 to result in an alternative moon cut configuration in FIG. 4 which includes an additional recess conforming to the shape of a lower body panel portion of a specific vehicle mounting configuration.

An additional top guide line is provided on the front face to define a horizontal raised rib 48 which spans the full width of the body in the lateral direction between the opposing side edges at a location which is parallel and spaced in close proximity below the perimeter wall spanning the central portion 34 of the top edge. The raised rib 48, the perimeter wall at the central portion 34 of the top edge, and the cutting guide lines all have a substantially identical thickness between front and rear faces to accommodate flush mounting against a suitable upright supporting surface.

The front face of the body further comprises a plurality of aperture receiving locations 50 where apertures are arranged to be formed in the mud flap through which fasteners can be received for mounting. A plurality of the aperture locations 50 are provided in a first row where the locations are horizontally spaced apart between the raised rib 48 and the perimeter wall of the central portion 34 of the top edge. Additional aperture receiving locations 50 are also provided at the top end of the extension portions 32. An additional horizontally spaced apart row of aperture receiving locations 50 are provided immediately below the two lower guide lines 46.

Each aperture receiving location 50 comprises a protrusion 52 integrally molded into the body of the mud flap which is raised in relation to the surrounding recessed central main portion of the front face. A central recess 54 at the center of each protrusion 52 corresponds to a reduced material thickness where fasteners are more readily punctured through the thickness of the mud flap. When used in cooperation with washers, the washer of each fastener aligns with the surrounding raised protrusion 52 of the aperture receiving location for optimally securing the mud flap to a supporting surface with fasteners.

All of the aperture receiving locations 50, the cutting guide lines, and the shape of the body are symmetrical about a vertical axis which is centered in the lateral direction between the opposing side edges. In this manner, the mud flap can be readily adapted to either left or right hand configurations in either mounting configuration.

In some embodiments an additional mounting bracket 56 is provided in the form of a rigid metal plate which is suitably folded and shaped for mounting between the top mounting end of the mud flap and corresponding mounting surfaces on the vehicle. The bracket 56 includes apertures 58 at spaced apart locations along a lower portion of the bracket which is arranged to be substantially flush mounted against the front face of the mud flap in parallel relation therewith. The apertures 58 correspond to generally horizontally extending slots for more ready alignment with corresponding aperture receiving locations 50. The height of the lower edge portion of the bracket 56 is arranged to span the height between the raised rib 48 and the perimeter wall at the central portion 34 of the top edge to assist in mounting of the plate in parallel arrangement to the mud flap body by evenly supporting the lower portion of the bracket 56 along the top and bottom edges thereof.

In use, the mounting configuration which is desired is first determined based on the vehicle type upon which the mud flap is to be mounted. The user then selects one of the patterns represented by the guide lines that match the mounting configuration of the vehicle. Due to the symmetrical nature of the mud flap, two mud flaps are typically cut in a symmetrical manner relative to one another to correspond to driver side and passenger side mud flaps. Cutting of the mud flap along the selected guide lines of the selected pattern permits the configuration of the top mounting end to be varied to match the mud flap mounting configuration of the prescribed vehicle. When cutting, it is preferable that the user cut along the top or outer sides of the selected guide lines such that the raised portion of the guide line remains attached to the body of the mud flap. In this manner the selected guide lines of the selected pattern form a portion of the resulting perimeter edge of the mud flap after cutting.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A universal mud flap comprising:
a molded body having a front face and a rear face spanning between a top mounting end arranged to be supported on a vehicle and a bottom end arranged to be suspended from the vehicle below the top mounting end;
a plurality of cutting guide lines integrally molded into at least one face of the molded body;
the plurality of cutting guide lines comprising at least two different patterns corresponding to respective different configurations of the top mounting end so as to be arranged for mounting on respective vehicles having different mud flap mounting configurations.

2. The universal mud flap according to claim 1 wherein the guide lines are integrally molded into only one face of the molded body.

3. The universal mud flap according to claim 1 wherein the guide lines are integrally molded into only the front face of the molded body.

4. The universal mud flap according to claim 1 wherein the cutting guide lines are symmetrical about an axis extending between the top mounting end and the bottom end.

5. The universal mud flap according to claim 1 wherein the cutting guide lines are raised in relation to respective recessed areas spanning between the cutting guide lines in the front face.

6. The universal mud flap according to claim 1 wherein there is provided a perimeter edge which is raised in relation to a central portion of the front face.

7. The universal mud flap according to claim 6 wherein the cutting guide lines are raised in relation to the central portion, the cutting guide lines being joined to the perimeter edge, and the cutting guide lines and the perimeter edge having a substantially identical thickness between the front and rear faces of the body.

8. The universal mud flap according to claim 1 wherein the cutting guide lines are raised in relation to respective recessed areas spanning between the cutting guide lines and span substantially a full thickness of the body between the front and rear faces of the body.

9. The universal mud flap according to claim 1 wherein there is provided a plurality of vertically oriented raised ribs on the front face of the body adjacent the bottom end, the cutting guide lines being raised in relation to respective recessed areas spanning between the cutting guide lines and having a thickness between the front and rear faces of the body corresponding to at least a majority of a thickness of the ribs between the front and rear faces of the body.

10. The universal mud flap according to claim 1 wherein a top edge of the top mounting end of the body comprises a pair of extension portions extending vertically upward from the body adjacent opposing side edges in relation to a central portion of the top edge, each extension portion comprising one of the cutting guide lines spanning thereacross between the respective side edge and the central portion of top edge.

11. The universal mud flap according to claim 10 wherein the guide lines comprise two guide lines which extend across the face of the body downwardly and inwardly from respective inners sides of the extension portions towards one another to a central apex spaced below the top edge of the body.

12. The universal mud flap according to claim 1 wherein the guide lines comprise two guide lines in a substantial V-shape which extend across the face of the body downwardly and inwardly from spaced apart positions at the top mounting end to a central apex spaced below the top edge of the body, one of the guide lines spanning laterally between opposing side edges of the body across the central apex.

13. The universal mud flap according to claim 12 wherein the cutting guide lines include a central guide line extend downwardly from the central apex and a pair of guide lines extending downwardly from the two guide lines in a substantial V-shape at spaced apart positions on opposing sides of the central guide line, the central guide line and said pair of guide lines being joined at respective bottom ends spaced below the central apex.

14. The universal mud flap according to claim 1 wherein the guide lines are raised in relation to respective recessed portions spanning therebetween and wherein the guide lines and a top edge of the top mounting end have an identical thickness between the front and rear faces of the body.

15. The universal mud flap according to claim 14 wherein there is provided a raised rib spanning horizontal across the front face locating the guide lines thereon, the raised rib being spaced below the top edge and having an identical thickness between the front and rear faces of the body as the top edge.

16. The universal mud flap according to claim 1 in combination with a mounting bracket having apertures formed therein in alignment with aperture receiving locations on the body adjacent the top mounting end.

17. The universal mud flap according to claim 1 wherein there is provided a plurality of aperture receiving locations on the body, each comprising a raised protrusion and a central recess in the raised protrusion which are integrally molded in the body.

18. The universal mud flap according to claim 1 wherein the guide lines are formed in the front face and there is provided a metallic accent plate integrally molded into the rear face of the body adjacent the bottom end.

19. A method of forming a mudflap to correspond to a prescribed vehicle, the method comprising:
integrally molding a body comprising a front face and a rear face spanning between a top mounting end and a bottom end, and a plurality of cutting guide lines integrally molded into at least one face of the molded body in which the plurality of cutting guide lines comprise at least two different patterns corresponding to respective different configurations of the top mounting end which are arranged for mounting on respective vehicles having different mud flap mounting configurations;
selecting the pattern corresponding to the mud flap mounting configuration of said prescribed vehicle; and
cutting the body along the cutting guide lines of only the selected pattern.

20. The method according to claim 19 including molding the body such that the guide lines and the perimeter edge are raised in relation to respective recessed portions of the front face spanning between the guide lines and the perimeter edge, and cutting the body alongside selected ones of the cutting guide lines such that said selected ones of the cutting guide lines remain attached to the bottom end of the body and form a portion of a perimeter edge of the body after cutting the body.
